(19) United States
(12) Patent Application Publication
(10) Pub. No.: US 2026/0284554 A1
(43) Pub. Date: Sep. 24, 2026

(54) ENVIRONMENTAL HEAT-DRIVEN LIQUID REGENERATOR SYSTEM

(71) Applicant: Kazadi Enterprises Ltd., Batavia, IL (US)

(72) Inventors: Sanza Kazadi, Batavia, IL (US); Jeremy Overcash, Naperville, IL (US); Nickolas Stukel, Naperville, IL (US); Rondy Ekyalongo, Aurora, IL (US)

(21) Appl. No.: 19/571,364

(22) Filed: Mar. 18, 2026

Related U.S. Application Data
(60) Provisional application No. 63/774,117, filed on Mar. 19, 2025.

(51) Int. Cl. B01D 19/00

(52) U.S. Cl. CPC B01D 19/0005

(57) ABSTRACT

Provided are regenerator devices capable of removing liquid from a solution. Air enters the regenerator through a desiccation chamber which enables air to entrain and remove vapor from liquid evaporation, also cooling the liquid in the process. The liquid is removed to a heat exchanger which restores heat to the liquid from environmental heat. The liquid is then moved back into the desiccation chamber. In some embodiments, the air leaving the desiccator travels through a solar collector where it is warmed and then travels out a chimney. The air flow is driven by the relative buoyancy of the warmed air compared to the surrounding air, which results in the initiation of new air from the surroundings into the regenerator.

### BACKGROUND

### Technical Field

The present disclosure relates to methods and systems for desiccating a liquid substance, and preferably, to methods and systems for desiccating a liquid substance while using spontaneously recovered lost heat of vaporization from the surrounding environment.

### Description of the Related Art

Regenerators are devices that remove water or another solvent from a solution. The process concentrates the solution by reducing its overall volume while retaining the non-liquid contents. A basic type of regenerator employs an evaporator where air is run over the liquid. The air entrains vapor emerging from the liquid and carries the vapor away. Since the liquid is in a dynamic equilibrium with its surroundings, removing the vapor that naturally emerges from the liquid results in the removal of some of the liquid from the bulk remainder of the liquid.

Evaporative regeneration works for some very dilute salt solutions but not well for other solutions that are very concentrated. Due to the concentration of these solutions, their deliquescence, or likelihood to absorb water (or other solvents, when appropriate), becomes very high. Unless the airflow is relatively dry, additional solvent carried by the airflow itself can be absorbed by the solution. This is a common problem when using environmental airflow to drive evaporation from a concentrated solution. Solutions typically become more dilute as a result of absorbing water vapor from the air in many terrestrial environments, though the specific threshold concentration varies with respect to the solution and the environmental conditions.

### BRIEF SUMMARY

The Summary and Abstract summarize some aspects of the present disclosure. Simplifications or omissions may have been made to avoid obscuring the purpose of the Summary or the Abstract. These simplifications or omissions are not intended to limit the scope of the present disclosure.

In one or more embodiments, an enhanced heat-driven liquid regenerator with environmental heat recovery is disclosed. Air enters the enhanced heat-driven liquid regenerator through a desiccation chamber which enables air to flow over a liquid. The flow of the air over the liquid entrains and removes vapor from the liquid via liquid evaporation. This liquid evaporation process also cools the remaining liquid. The cooled liquid is then removed to a heat exchanger via a first conduit that restores heat to the liquid from environmental heat captured from the surrounding environmental. The rewarmed liquid is then moved back into the desiccation chamber via a second conduit.

In some embodiments, an enhanced heat-driven liquid regenerator with environmental heat recovery is disclosed. This enhanced heat-driven liquid regenerator incorporates airflow generated by electric fans to evaporate water from a solution and environmental heat to stabilize the temperature of the liquid being regenerated.

In other embodiments, yet another enhanced heat-driven liquid regenerator with environmental heat recovery is disclosed. This enhanced heat-driven liquid regenerator incorporates an operatively connected solar chimney. The movement of buoyant air upwards through the solar chimney generates the airflow into the regenerator system. Additionally, the solar chimney is equipped with a heating mechanism that limits (or eliminates) the condensation of liquid, and therefore, the loss of heat from the warmed air that drives the buoyant airflow movement upwards through the length of the chimney.

### BRIEF DESCRIPTION OF THE SEVERAL VIEWS OF THE DRAWINGS

FIG. 1 shows an enhanced heat-driven liquid regenerator with environmental heat recovery.

FIG. 2 shows an enhanced heat-driven liquid regenerator with environmental heat recovery with airflow generated by a fan.

FIG. 3 shows an enhanced heat-driven liquid regenerator with environmental heat recovery with airflow generated by a solar chimney.

FIG. 4 shows a process flow of air, liquid, and heat through the enhanced heat-driven liquid regenerator with environmental heat recovery.

### DETAILED DESCRIPTION

Persons of ordinary skill in the art will understand that the present disclosure is illustrative only and not in any way limiting. Other embodiments of the presently disclosed system and method readily suggest themselves to such skilled persons having the assistance of this disclosure.

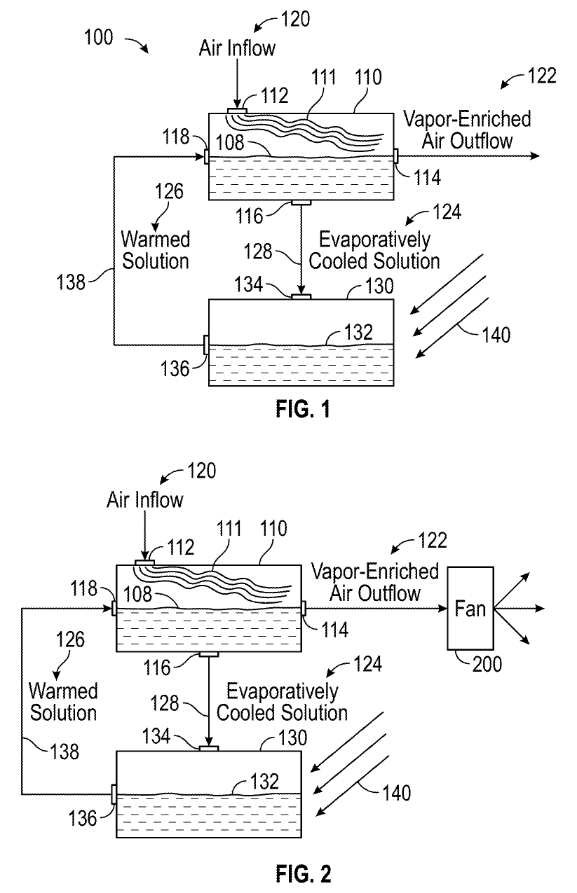

Each of the features and teachings disclosed herein can be utilized separately or in conjunction with other features and teachings to provide a system and method for liquid regeneration. Representative examples utilizing many of these additional features and teachings, both separately and in combination, are described in further detail with reference to attached FIGS. 1-4. This detailed description is merely intended to teach a person of ordinary skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice all aspects of the teachings of the present system and method.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples in some embodiments. In some embodiments, the dimensions and the shapes of the components shown in the figures are intended to limit the dimensions and the shapes of the components.

As described herein, a term herein referred to as “desiccation” is defined as a process of vaporizing, dehumidifying, and/or drying out liquid. In various embodiments described herein, the liquid undergoing this “desiccation” process may be water or another substance in a liquid state.

Additionally, as referred to herein, a “desiccator” is a device designed to vaporize, dehumidify, and/or dry out liquid within the device. For example, a desiccator (or desiccation chamber) may partially vaporize a pool of water or another pool of liquid with an incoming flow of air into the device.

One modern method of generating airflow employs electric fans. These fans can be powered in a variety of ways including grid-based electricity, battery-based electricity, wind-based electricity, or solar-based electricity. While this is a straightforward solution, it also requires significant electricity. For instance, a common dehumidifier, which can be used to regenerate low concentration solutions, uses fans and pumps to move the solution and create airflow. The power required may be in the range of 90-100 Watts, which is a significant amount of energy.

Another option for generating airflow is the use of a solar chimney system. Solar chimneys use solar-based heat to generate airflow. These solar chimney systems use solar energy to warm air contained within a solar collector region of the system. The warmed air, which becomes warmer than the environmental air, becomes relatively buoyant. Due to the relative buoyancy, the warm air within the system moves upward, eventually exiting the top of the chimney. The movement of the warmed air results in more, relatively cooler air being drawn into the chimney from the local environment, and becoming warmed within the solar chimney system. This cycle continues the movement of the air, resulting in sustained airflow into and out of the solar chimney.

Typically, solar chimney systems are comprised of a solar collector and a chimney. Usually, these two components are combined into a single component to create a multifunctional solar chimney system. The solar collector is a device which receives radiant solar energy, transforms that energy to heat, and transfers that heat into air contained within the solar chimney system. The chimney is a substantially vertical air pathway, that is typically oriented as close to vertical as possible. Warm air entering the solar chimney is channeled upward, and its upward movement creates a low pressure region at the bottom of the solar chimney, which acts to draw in more air into the solar chimney system.

Solar chimneys are used to move air into enclosed spaces, through those enclosed spaces, and then out of the enclosed spaces. As a result, solar chimneys can enhance the freshness of air in the enclosed space, as well as maintaining environmental stability, despite the tendency of solar insolation to otherwise warm the enclosed space. The airflow itself is a form of energy that can be used to drive wind turbines and generate electricity, as well as to dry food, wood, and other substances.

When used as a dryer, solar chimneys are typically enhanced with an added desiccator. A desiccator is a device which uses airflow to draw liquid out of a solution by encouraging the liquid to transform into vapor and entraining the vapor in the airflow moving through the desiccator. This entrained airflow dries the solution using the heat and airflow. The heat is typically captured from solar insolation impacting the enclosed area of the solar chimney-based dryer. The enclosed area may include both the solar collector and the desiccator. In such an embodiment, the heat captured due to the solar insolation serves to not only enhance the evaporation of the liquid from the solution, but also to provide an initiating force for the airflow. When the desiccator is filled with a liquid solution and the liquid being driven out is a solvent, then the system is a solar chimney-based regenerator.

In some embodiments, solar insolation is used to heat the surfaces of the solar collector and to directly heat the air flowing through the solar collector. As the air flows through a desiccation chamber, some of the heat is consumed transforming the liquid in the solution into vapor. This action cools the air flowing through the desiccation chamber, reducing its buoyancy, and the rate at which air flows through the system. The amount of water that can be evaporated is limited by the amount of heat absorbed from the solar radiation, and the rate at which air flows through the system. The rate of air flow is itself a function of the heat absorbed, and the rate of evaporation of the liquid in the substance being dried. If too much water is evaporated, the resulting air temperature becomes lower than the temperature of the surrounding air. This eliminates the buoyancy of the air and stops the airflow. As a result, the evaporative capacity is limited by a fraction of the amount of solar energy impacting the system.

Notably, such a solar chimney-based regenerator system has major limitations. For example, the main source of energy for this system is solar energy, which drives the heating, evaporation, and air movement. Additionally, the temperature of the air flowing through is, by necessity, warmer than the environment. This results in there being no way to capture more energy than the incident solar insolation. As a result of the evaporation, the material being dried cools, and the material drying rate drops. The only source of heat to counterbalance the evaporation is the solar-derived heat, which is variable throughout the day and limited by the size of the solar collector. As a result, the material falls below the temperature of the incoming warmed air, and settles at a temperature where the sensible heating (due to the warmed air directly contacting the substance being dried), equals the amount of cooling of the same substance (due to the evaporation of the liquid). The heat required to maintain this balance is limited by the capacity of the solar collector and the desiccation chamber to capture solar insolation. Additionally, this capacity is limited by the size of the components and the time of day, as well as the effects of cloud cover, smoke, and the like, which may divert or block sunlight.

Additionally, the environment of the solar chimney and the air that is being drawn into the system contains heat. Since the air going through the solar chimney must be warmer than the environment, none of the heat initially in the air can drive the solar chimney or the evaporation in this configuration. In particular, the only energy that can be used to recover the heat of vaporization lost due to evaporation is the energy inherent to the solar insolation. The thermal energy in the air surrounding the solar chimney may greatly exceed that captured by the solar collector. As such, the air, ground, and the other objects surrounding the solar chimney all contribute to that capture not being able to use that thermal energy of the surroundings, which eliminates a significant energy reservoir. Therefore, an improved configuration of a solar chimney-based regenerator system employs desiccation, which is supported by energy that is already available in the environment. The present disclosure improves upon solar chimney-based regenerator architecture by using environmental energy to enhance its evaporative process.

In various embodiments of the Environmental Heat-Driven Liquid Regenerator System, a thermally-regenerating desiccator enables the re-acquisition of thermal energy by the solvent or solution being dried after it has been removed due to evaporation. Unlike a conventional desiccator in which water does not move, the thermally-regenerating desiccator moves the cooled water into a heat-absorbing exchanger to enable the cooled water to absorb heat from the environment. Once heated, the re-heated water then flows back into the airflow. This structure and functionality of the thermally-regenerating desiccator has the effect of stabilizing the temperature of the water and therefore stabilizing its ability to vaporize in the airflow.

Shown in FIG. 1 is an Environmental Heat-Driven Liquid Regenerator System 100. In some embodiments, the Environmental Heat-Driven Liquid Regenerator System 100 includes a desiccation chamber 110 and a liquid-based heat exchanger 130 that are operatively connected to each other. The desiccation chamber 110 is partially filled with a liquid 108 (or other solution). However, there is enough space left between the liquid 108 and the top of the desiccation chamber 110 for airflow 111 over the liquid 108 within the desiccation chamber 110. In another aspect of some embodiments, the desiccation chamber 110 includes an external air inlet 112, and vapor-enriched air outlet 114, a cooled solution outlet 116, and a warmed solution inlet 118.

Regenerators described herein can include one or more desiccation chambers 110. The desiccation chamber 110 is configured to enable air inflow 120 into the desiccation chamber 110 via the external air inlet 112. The airflow 111 with the desiccation chamber 110 removes water vapor from the liquid 108 contained within the desiccation chamber 110. When air flows over the liquid 108, the airflow 111 entrains the vapor emitted from the liquid 108 and removes the vapor from the desiccation chamber 110. The desiccation chamber 110 is configured to enable air flow of humidified (vapor-enriched) air 122 out of the desiccation chamber 110 via the vapor-enriched air outlet 114.

Additionally, the airflow 111 through the desiccation chamber 110 comes into contact with the liquid 108, and results in cooling of the liquid 108 due to evaporation and removal of the heat of vaporization from the liquid 108. The biased dynamic equilibrium of liquid evaporation and condensation acts to remove the condensation, and results in a net removal of the liquid 108 via evaporation. As long as the vapor content of the airflow 111 travelling through the desiccation chamber 110 is lower than the equilibrium vapor content of stagnant air above the liquid 108, a net loss of liquid 108 occurs. Due to the evaporation of the liquid 108 into the airflow 111, the remaining liquid becomes evaporatively cooled liquid 124. The cooling of the liquid results in lowering its equilibrium vapor pressure, which in turn, reduces the evaporation rate of the liquid. Accordingly, the desiccation chamber 110 is configured to enable the flow of the evaporatively cooled liquid 124 out of the desiccation chamber 110 via the cooled solution outlet 116.

As a result, the evaporatively cooled liquid 124 is moved into the heat exchanger 130, via a cooled solution transfer conduit 128 that travels from the desiccation chamber 110 to the heat exchanger 130. The heat exchanger 130 is configured and positioned to absorb environmental heat 140. The heat exchanger 130 includes a cooled solution inlet 134 and a warmed solution outlet 136. The evaporatively cooled liquid 124 travels through the cooled solution transfer conduit 128 that connects to the heat exchanger 130 via the cooled solution inlet 134. This heat exchanger 130 transfers heat from the surrounding environment into the evaporatively cooled liquid 124 entering the heat exchanger 130 to create warmed liquid 132 within the heat exchanger 130.

This heat transfer from the surrounding environment may be from solar radiation from the sun or conductive heat transfer from surroundings materials. This heat transfer effectively recovers the heat of vaporization lost due to the evaporation of the liquid 108 in the desiccation chamber 110. The warmed liquid 132 is then moved back into the desiccation chamber 110 via a warmed solution transfer conduit 138. Specifically, the warmed liquid 132 exits the heat exchanger 130 via the warmed solution outlet 136 into the warmed solution transfer conduit 138. The desiccation chamber 110 is configured to receive the flow of inbound warmed solution 126 through the warmed solution transfer conduit 138 via the warmed solution inlet 118. In this manner, the liquid regeneration cycle between the desiccation chamber 110 and the heat exchanger 130 is maintained.

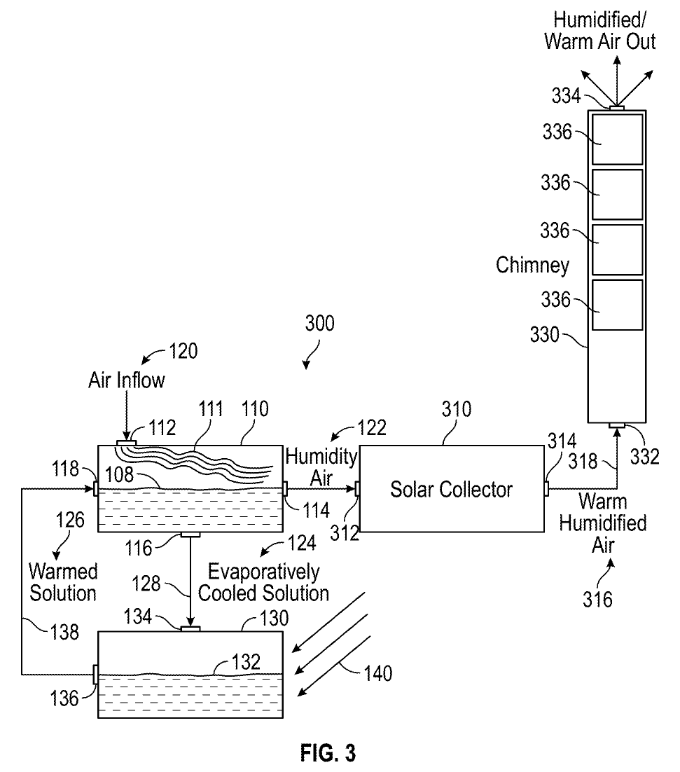

The humidified (vapor-enriched) air 122 flows out of the desiccation chamber 110 via the vapor-enriched air outlet 114. This outward drawing of the humidified (vapor-enriched) air 122 creates a low pressure effect within the desiccation chamber 110 that draws air inflow 120 from the surrounding environment into the desiccation chamber 110 via the external air inlet 112. There are numerous techniques that can be used to draw the humidified (vapor-enriched) air 122 out of the desiccation chamber 110 (and/or push air through the desiccation chamber 110); however, techniques that require little or no energy are preferred. FIGS. 2 and 3 portray two embodiments that are used to draw the humidified (vapor-enriched) air 122 flows out of the desiccation chamber 110.

Referring now to FIG. 2, in this embodiment of the Environmental Heat-Driven Liquid Regenerator System 100 one or more fans 200 are used to initiate flow the humidified (vapor-enriched) air 122 out of the desiccation chamber 110. Notably, this embodiment includes some of the components described in FIG. 1, such as the desiccation chamber 110, the heat exchanger 130, and the like, plus the addition of the one or more fans 200. An attribute of the Environmental Heat-Driven Liquid Regenerator System 100 is the initiation of airflow 111 through the desiccation chamber 110 and liquid flow through the heat exchanger 130. One such technique to achieve this airflow is through the use of one or more electric fans 200 that are (1) positioned at or near an exit of the desiccation chamber 110 to draw air through the desiccation chamber 110, (2) positioned at or near an entrance of the desiccation chamber 110 to push air through the desiccation chamber 110, or (3) both. While this technique requires some modest amount of electrical energy, this energy can be provided in a variety of ways, including solar electricity, battery-based electricity, grid-based electricity, or local electricity generation. The vapor-enriched air 122 flowing out of this fan-based embodiment of the Environmental Heat-Driven Liquid Regenerator System 100 is humidified and cooled. Such humidification and cooling can be used for many applications, including various types of refrigeration and cooling.

As shown in FIG. 3, in this embodiment of the Environmental Heat-Driven Liquid Regenerator System 100 a solar chimney 300 is used to initiate the flow the humidified (vapor-enriched) air 122 out of the desiccation chamber 110. In this manner, airflow is provided by combining the regenerator with a solar chimney 300. In some embodiments, the solar chimney 300 includes a solar collector 310 and a chimney 330 that are operatively connected by a warmed air conduit 318. The solar collector 310 includes an air inlet 312, through which humidified (vapor-enriched) air 122 enters the solar collector 310.

The solar collector 310 is operatively connected to the desiccation chamber 110. The vapor-enriched air 122 with entrained liquid vapor exits the desiccation chamber 110 via the vapor-enriched air outlet 114. In this configuration, the vapor-enriched air 122 leaving the desiccation chamber 110 continues along and enters the solar collector 310, via air inlet 312, where the vapor-enriched air 122 is warmed by insolation and becomes warmed air 122. The solar collector 310 further includes an air outlet 316 through which the warmed air 122 exits the solar collector 310 into the warmed air conduit 318.

The chimney 330 includes chimney air inlet 332 and a chimney air outlet 334. The warmed air 122 continues from the warmed air conduit 318 into the chimney via the chimney air inlet 332. The warmed air 122 continues upwards through the vertical (or substantially vertical) chimney 330, wherein it exits out of the chimney 330 via the chimney air outlet 334, into the surrounding environment due to relative buoyancy of the warmed air 122 compared with surrounding environmental air. The upward travel of the warm air 122 with entrained liquid vapor upward and out of the solar chimney 330 creates low pressure within the solar collector 310 that draws air inflow 120 into the desiccation chamber 110 via the external air inlet 112.

While traveling up the chimney 330, the vapor in the warmed air 122 may begin to condense on the side of the chimney. This process, if it was allowed to occur, would transfer heat out of the warmed air 122 onto the inner surface of the chimney 330. Such a transfer would reduce the buoyancy of the air warmed air 122 traveling through the chimney, possibly stalling the upward motion of the warmed air 122 altogether. To prevent this action form occurring, the chimney 330 is purposely warmed in some embodiments. This warming process ensures that no condensation can take place in the chimney 330 and the warmed air 122 travels upward through the length of the chimney 330 and into the environment, via the chimney air outlet 334. In some embodiments, the warming process is achieved using a heating mechanism 336 to heat the chimney 330, and prevent condensation of liquid within the solar chimney 330 as warmed air 122 travels upward and out of the solar chimney 330. In one embodiment, the heating mechanism 336 is a solar thermal system. In another embodiment, the heating mechanism 336 is one or a plurality of electric heating elements.

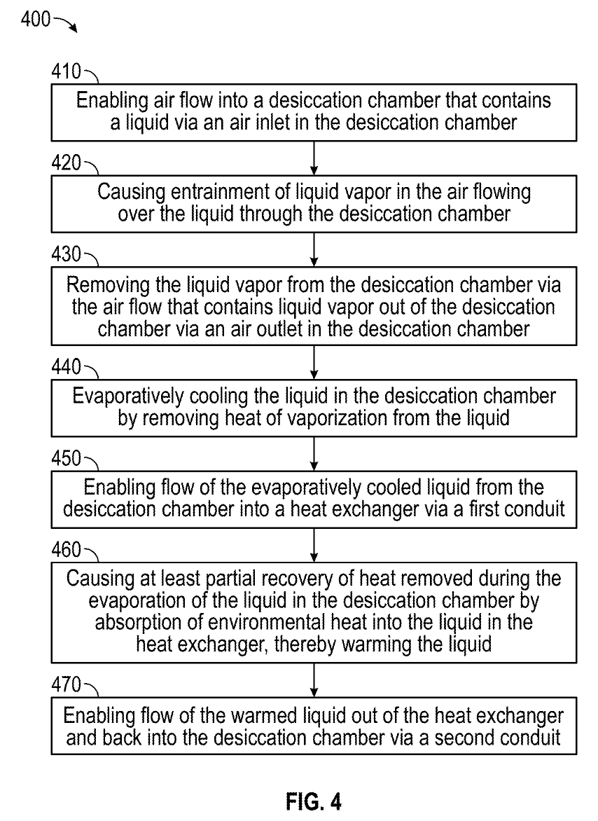

As shown in FIG. 4, a method 400 of operating an enhanced heat-driven liquid regenerator with environmental heat recovery is disclosed. In some embodiments, the liquid regenerator may be desiccation chamber 110 of FIG. 1, as illustrated in FIGS. 1-3. FIG. 4 provides a flowchart of the method of operating the enhanced heat-driven liquid regenerator with environmental heat recovery. At operation 410, air flow is enabled into a desiccation chamber that contains a liquid via an air inlet in the desiccation chamber. At operation 420, entrainment of liquid vapor is caused by the air flowing over the liquid through the desiccation chamber. At operation 430, the liquid vapor is removed from the desiccation chamber via the air flow that contains liquid vapor out of the desiccation chamber via an air outlet in the desiccation chamber. At operation 440, the liquid in the desiccation chamber is evaporatively cooled by removing the heat of vaporization from the liquid. At operation 450, the flow of the evaporatively cooled liquid from the desiccation chamber into a heat exchanger is enabled via a first conduit. At operation 460, at least partial recovery of the heat removed during the evaporation of the liquid in the desiccation chamber is caused by absorption of environmental heat into the liquid in the heat exchanger, thereby warming the liquid. At operation 470, flow of the warmed liquid out of the heat exchanger and back into the desiccation chamber is enabled via a second conduit.

### EXAMPLE EMBODIMENTS

### Example 1

In one embodiment, an environmental heat-driven liquid regenerator system includes a desiccation chamber and a heat exchanger. The desiccation chamber contains a liquid and air, as well as an air inlet, an air outlet, a liquid outlet, and a liquid inlet. The desiccation chamber is configured to enable air flow into the desiccation chamber via the air inlet, enable air flow of humidified air out of the desiccation chamber via the air outlet, enable outbound liquid flow via the liquid outlet, and receive inbound liquid flow via the liquid inlet. The heat exchanger includes a liquid inlet and a liquid outlet. The evaporatively cooled liquid flows from the desiccation chamber liquid outlet into the heat exchanger liquid inlet via a first conduit. The air flowing through the desiccation chamber comes into contact with the liquid, resulting in entrainment of liquid vapor in the air, removal of the liquid vapor from the desiccation chamber, cooling of the liquid due to evaporation, and removal of heat of vaporization from the liquid. The heat exchanger is configured and positioned to absorb environmental heat. The absorption of the environmental heat by liquid in the heat exchanger causes at least partial recovery of the heat removed during the evaporation of the liquid in the desiccation chamber. After recovering heat from the environment, the liquid warmed in the heat exchanger flows from the heat exchanger liquid outlet into the desiccation chamber liquid inlet via a second conduit.

Optionally, the air flow is initiated by one or more fans operatively connected to the desiccation chamber via a third conduit that draws humidified air out of the desiccation chamber air outlet, blows air into the desiccation chamber air inlet, or both. Optionally, the air flow is initiated by a solar chimney operatively connected to the desiccation chamber via a third conduit that draws humidified air out of the desiccation chamber air outlet. Optionally, the environmental heat-driven liquid regenerator system further includes a chimney heating system that heats a chimney section in the solar chimney, and prevents condensation of liquid from humidified air travelling along a length of the chimney section as the humidified air travels up through the chimney section. Optionally, the environmental heat absorbed by liquid in the heat exchanger is received from a solar thermal system. Optionally, the environmental heat absorbed by liquid in the heat exchanger is received from a conduction heating system.

### Example 2

In another embodiment, an environmental heat-driven liquid regenerator system includes a desiccation chamber, a heat exchanger, and a solar chimney. The desiccation chamber contains a liquid and air that flows over the liquid. The desiccation chamber is configured to enable air flow into the desiccation chamber via the air inlet, enable air flow of humidified air out of the desiccation chamber via the air outlet, enable outbound liquid flow via the liquid outlet, and receive inbound liquid flow via the liquid inlet. The heat exchanger includes a liquid inlet and a liquid outlet. The evaporatively cooled liquid flows from the desiccation chamber liquid outlet into the heat exchanger liquid inlet via a first conduit. The air flowing through the desiccation chamber comes into contact with the liquid, resulting in entrainment of liquid vapor in the air, removal of the liquid vapor from the desiccation chamber, cooling of the liquid due to evaporation, and removal of heat of vaporization from the liquid. The heat exchanger is configured and positioned to absorb environmental heat. The absorption of the environmental heat by liquid in the heat exchanger causes at least partial recovery of the heat removed during the evaporation of the liquid in the desiccation chamber. After recovering heat from the environment, the liquid warmed in the heat exchanger flows from the heat exchanger liquid outlet into the desiccation chamber liquid inlet via a second conduit.

The solar chimney includes a solar collector and a chimney section. The solar collector operatively connects to the desiccation chamber via a third conduit. The humidified air with entrained liquid vapor exits the desiccation chamber via the air outlet, enters the solar collector, and is warmed by solar insolation in the solar collector. The chimney section is operatively connected to the solar collector via a fourth conduit. The warmed air with entrained liquid vapor exits the solar collector, enters the chimney, and travels upward out of the chimney due to relative buoyancy of the warmed air compared to surrounding air. When the warm air with entrained liquid vapor travels upward and out of the solar chimney it creates low pressure within the solar collector that draws air flow into the desiccation chamber.

Optionally, the environmental heat-driven liquid regenerator system further includes a heating mechanism to heat the solar chimney, and prevent condensation of liquid from the humidified air within the solar chimney as the humidified air travels through the solar chimney. Optionally, the heating mechanism is a solar thermal system. Optionally, the heating mechanism is one or a plurality of electric heating elements.

### Example 3

Other embodiments are also disclosed that include an environmental heat-driven liquid regenerator method. The method includes: enabling air flow into a desiccation chamber that contains a liquid via an air inlet in the desiccation chamber; causing entrainment of liquid vapor in the air flowing over the liquid through the desiccation chamber; removing the liquid vapor from the desiccation chamber via the air flow that contains liquid vapor out of the desiccation chamber via an air outlet in the desiccation chamber; evaporatively cooling the liquid in the desiccation chamber by removing heat of vaporization from the liquid; enabling flow of the evaporatively cooled liquid from the desiccation chamber into a heat exchanger via a first conduit; causing at least partial recovery of heat removed during the evaporation of the liquid in the desiccation chamber by absorption of environmental heat into the liquid in the heat exchanger, thereby warming the liquid; and enabling flow of the warmed liquid out of the heat exchanger and back into the desiccation chamber via a second conduit.

Optionally, the environmental heat-driven liquid regenerator method further includes receiving at a solar collector that is operatively connected to the desiccation chamber, the air flow containing entrained liquid vapor that exited the desiccation chamber via the air outlet. Optionally, the environmental heat-driven liquid regenerator method further includes warming the air flow containing entrained liquid vapor that entered the solar collector by solar insolation on the solar collector. Optionally, the solar collector is a component of a solar chimney that is operatively connected to the desiccation chamber. Optionally, the warmed air with entrained liquid vapor exits the solar collector enters the solar chimney. Optionally, the warmed air travels upward within the solar chimney and out of the solar chimney due to relative buoyancy of the warmed air compared with surrounding air that is external to the solar chimney. Optionally, the upward travels of the warmed air with entrained liquid vapor upward and out of the solar chimney creates low pressure within the solar collector that draws air flow into the operatively connected desiccation chamber via the air inlet. Optionally, the solar chimney includes a heating mechanism to heat the chimney, and prevent condensation of liquid within the solar chimney as warmed air travels upward and out of the solar chimney. Optionally, the heating mechanism is one or more of a solar thermal system and one or more a plurality of electric heating elements.

### Example 4

Still other embodiments are also disclosed that include an environmental heat-driven liquid regenerator method. The method includes: enabling air flow in a desiccation chamber over a liquid that causes entrainment of liquid vapor in the air flow; removing the liquid vapor from the desiccation chamber via the air flow that contains liquid vapor out of the desiccation chamber; evaporatively cooling the liquid in the desiccation chamber by removing heat of vaporization from the liquid; enabling flow of the evaporatively cooled liquid from the desiccation chamber into a heat exchanger via a first conduit; causing at least partial recovery of heat removed during the evaporation of the liquid in the desiccation chamber by absorption of the environmental heat into the liquid while in the heat exchanger, thereby warming the liquid; and enabling flow of the warmed liquid from the heat exchanger back into the desiccation chamber via a second conduit.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but are not intended to limit the dimensions and the shapes shown in the examples.

Unless the context requires otherwise, throughout the specification and claims which follow, the word “comprise” and variations thereof, such as “comprises” and “comprising,” are to be construed in an open, inclusive sense, that is, as “including, but not limited to.” Reference throughout this specification to “one implementation” or “an implementation” means that a particular feature, structure, or characteristic may be combined in any suitable manner in one or more implementations. As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise. The headings and Abstract of the Disclosure provided herein are for convenience only and do not interpret the scope or meaning of the implementations.

Some portions of the detailed descriptions herein may be presented in terms of algorithms and symbolic representations of operations. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

All publications, including patent documents, scientific articles, and/or databases referred to in this application, are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

While the disclosure has been described with respect to a limited number of embodiments, those skilled in the art, having benefit of this disclosure, will appreciate that other embodiments can be devised which do not depart from the scope of the disclosure. Accordingly, the scope of the disclosure should be limited only by the attached claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. An environmental heat-driven liquid regenerator system, comprising:
a desiccation chamber that contains a liquid and air, the desiccation chamber including an air inlet, an air outlet, a liquid outlet, and a liquid inlet, wherein the desiccation chamber is configured to enable air flow into the desiccation chamber via the air inlet, enable air flow of humidified air out of the desiccation chamber via the air outlet, enable outbound liquid flow via the liquid outlet, and receive inbound liquid flow via the liquid inlet; and
a heat exchanger that includes a liquid inlet and a liquid outlet, wherein evaporatively cooled liquid flows from the desiccation chamber liquid outlet into the heat exchanger liquid inlet via a first conduit,
wherein air flowing through the desiccation chamber comes into contact with the liquid, resulting in entrainment of liquid vapor in the air, removal of the liquid vapor from the desiccation chamber, cooling of the liquid due to evaporation, and removal of heat of vaporization from the liquid,
wherein the heat exchanger is configured and positioned to absorb environmental heat, wherein absorption of the environmental heat by liquid in the heat exchanger causes at least partial recovery of the heat removed during the evaporation of the liquid in the desiccation chamber, and
wherein after recovering heat from the environment, the liquid warmed in the heat exchanger flows from the heat exchanger liquid outlet into the desiccation chamber liquid inlet via a second conduit.

2. The system of claim 1, wherein the air flow is initiated by one or more fans operatively connected to the desiccation chamber that move humidified air through the desiccation chamber air outlet.

3. The system of claim 1, wherein the air flow is initiated by a solar chimney operatively connected to the desiccation chamber via a third conduit that draws humidified air out of the desiccation chamber air outlet.

4. The system of claim 3, further comprising:
a chimney heating system that heats a chimney of the solar chimney and prevents condensation of liquid from humidified air travelling along a length of the solar chimney as the humidified air travels up through the chimney.

5. The system of claim 1, wherein the environmental heat absorbed by liquid in the heat exchanger is received from a solar thermal system.

6. The system of claim 1, wherein the environmental heat absorbed by liquid in the heat exchanger is received from a conduction heating system.

7. An environmental heat-driven liquid regenerator system, comprising:
a desiccation chamber that contains a liquid and air, wherein the desiccation chamber is configured to enable air flow into the desiccation chamber via an air inlet, enable air flow of humidified air out of the desiccation chamber via an air outlet, enable outbound liquid flow via a liquid outlet, and receive inbound liquid flow via a liquid inlet;
a heat exchanger that is operatively connected with the desiccation chamber, wherein evaporatively cooled liquid flows from the desiccation chamber into the heat exchanger via a first conduit,
wherein air flowing through the desiccation chamber comes into contact with the liquid, resulting in entrainment of liquid vapor in the air, removal of the liquid vapor from the desiccation chamber, cooling of the liquid due to evaporation, and removal of heat of vaporization from the liquid,
wherein the heat exchanger is configured and positioned to absorb environmental heat, wherein absorption of the environmental heat by liquid in the heat exchanger causes at least partial recovery of the heat removed during the evaporation of the liquid in the desiccation chamber, and
wherein after recovering heat from the environment, the liquid warmed in the heat exchanger flows from the heat exchanger back into the desiccation chamber via a second conduit;
a solar collector operatively connected to the desiccation chamber via a third conduit, wherein the air with entrained liquid vapor exiting the desiccation chamber via the air outlet enters the solar collector and is warmed by solar insolation on the solar collector; and
a chimney operatively connected to the solar collector via a fourth conduit, wherein warmed air with entrained liquid vapor exits the solar collector, enters the chimney, and travels upward out of a top of the chimney due to relative buoyancy of the warmed air compared to surrounding air,
wherein the travelling of the warm air with entrained liquid vapor upward and out of the solar chimney creates low pressure within the solar collector that draws air flow into the desiccation chamber.

8. The system of claim 7, further comprising:
a heating mechanism to heat the solar chimney and prevent condensation of liquid from the humidified air within the solar chimney as the humidified air travels through the solar chimney.

9. The system of claim 8, wherein the heating mechanism is a solar thermal system.

10. The system of claim 8, wherein the heating mechanism is one or more of a plurality of electric heating elements.
